(19) United States
(12) Patent Application Publication
(10) Pub. No.: US 2013/0167366 A1
(43) Pub. Date: Jul. 4, 2013

(54) MOUNTING APPARATUS FOR CIRCUIT BOARD

(71) Applicants: WEN-HU LU, Shenzhen City (CN); PO-WEN CHIU, Tu-Cheng (TW); ZHAN-YANG LI, Shenzhen City (CN)

(72) Inventors: WEN-HU LU, Shenzhen City (CN); PO-WEN CHIU, Tu-Cheng (TW); ZHAN-YANG LI, Shenzhen City (CN)

(21) Appl. No.: 13/650,294

(22) Filed: Oct. 12, 2012

(30) Foreign Application Priority Data
Dec. 28, 2011 (CN) 201110446804.0

(51) Int. Cl. B23P 19/00

(52) U.S. Cl. 29/700

(57) ABSTRACT

A mounting apparatus includes a chassis and a fixing module. The chassis includes a bottom plate. The fixing module includes a securing member and a blocking member. The securing member is secured to the bottom plate. The blocking member is pivoted to the securing member and configured to block a circuit board, to prevent the circuit board from moving along a direction perpendicular to a plane that is perpendicular to the bottom plate.

### BACKGROUND

1. Technical Field

The present disclosure relates to mounting apparatuses, more particularly to a mounting apparatus for a circuit board.

2. Description of Related Art

Printed circuit boards (PCB), such as a motherboard or an expansion card, must be firmly mounted in computer enclosures. In related art, the PCB is directly mounted to a computer chassis through rivets or screws. The computer chassis may also form protrusions for receiving the rivets or screws and supporting the PCB. When the computer enclosure is vibrated, the PCB may easily move relative to the enclosure.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, cutaway, isometric view of an embodiment of a mounting apparatus and a circuit board.

FIG. 2 is an enlarged view of the circled portion II of FIG. 1.

FIG. 3 is an exploded, isometric view of a fixing module of FIG. 1.

FIG. 4 is similar to FIG. 3, but viewed from a different aspect.

FIG. 5 is an assembled, cutaway view of the mounting apparatus and the circuit board of FIG. 1.

FIG. 6 is an enlarged view of the circled portion VI of FIG. 6.

FIG. 7 is another assembled, cutaway view of the mounting apparatus and the circuit board of FIG. 1.

FIG. 8 is an enlarged view of the circled portion VIII of FIG. 7.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

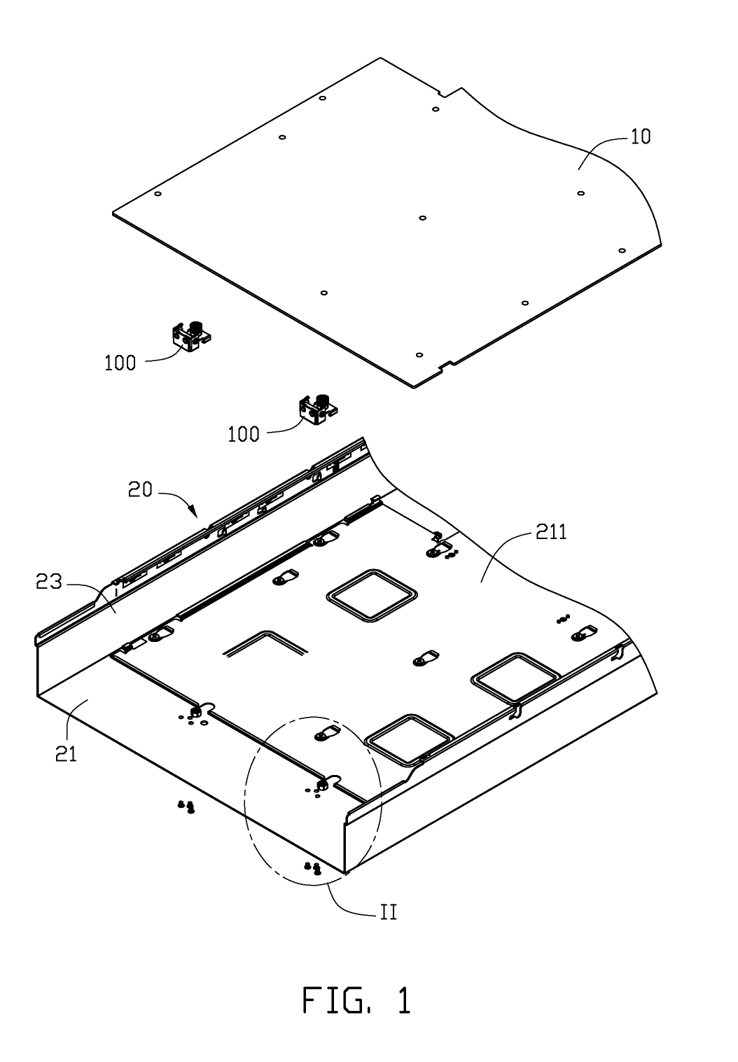

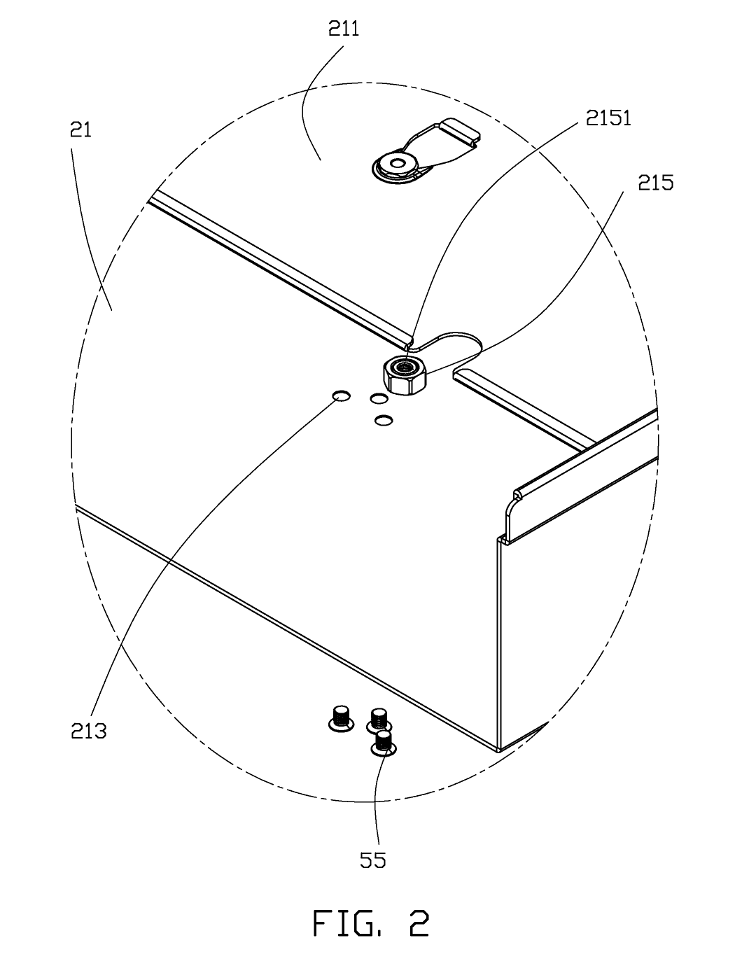

FIGS. 1-3 illustrate an embodiment of a mounting apparatus configured to secure a circuit board 10. The mounting apparatus includes a chassis 20 and two fixing modules 100.

The chassis 20 includes a bottom plate 21, two sidewalls 23, and a rear plate, (not shown) located on the bottom plate 21. The two sidewalls 23 extend from two opposite sides of the bottom plate 21. The two sidewalls 23 are substantially parallel to each other and perpendicular to the bottom plate 21. A bearing board 211 is attached to the bottom plate 21 and is configured for supporting the circuit board 10. The bottom plate 21 defines three securing holes 213, located in front of the bearing board 211, in two locations and corresponding to each of the two fixing modules 100. A fixing portion 215, defining a fixing hole 2151, is located on the bottom plate 21, corresponding to each of the two fixing modules 100. The circuit board 10 is attached to the bearing board 211 and is located between the two sidewalls 23 and the rear plate.

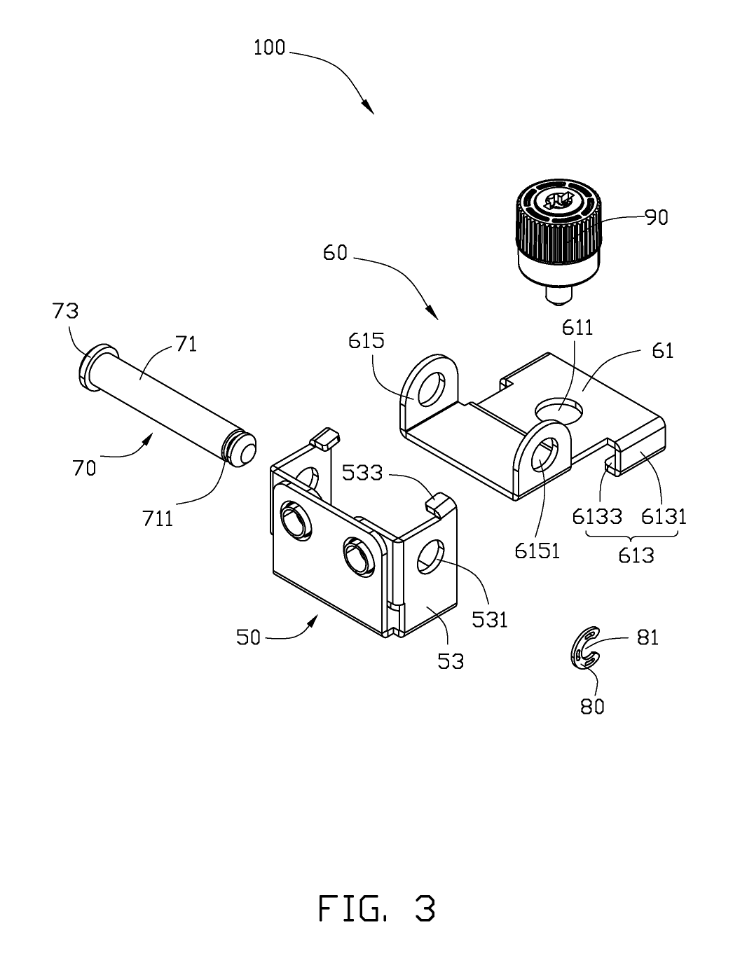

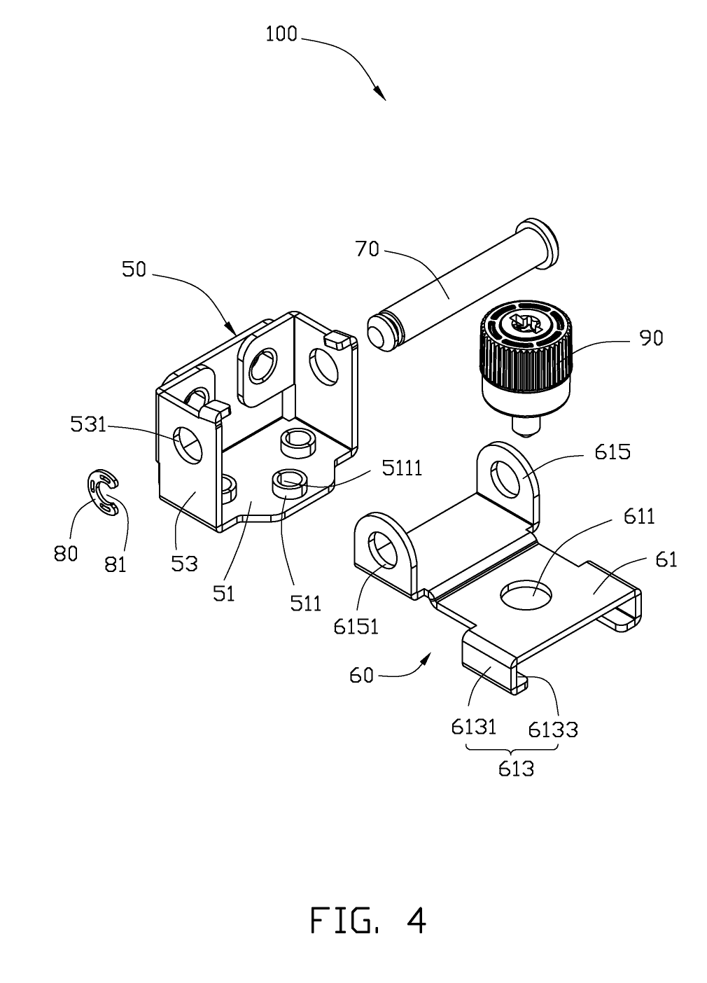

Referring to FIGS. 3 and 4, each of the two fixing modules 100 includes a securing member 50, a blocking member 60, a pivot shaft 70, a snap ring 80, and a locking member 90.

The securing member 50 includes a securing board 51 and two positioning pieces 53. Three installation portions 511 protrude from the securing board 51, and each of the installation portions 511 defines an installation hole 5111. The two positioning pieces 53 extend upwards from two opposite sides of the securing board 51. The blocking member 60 is rotatably secured to the two positioning pieces 53. The two positioning pieces 53 are substantially parallel to each other and perpendicular to the securing board 51. A positioning hole 531 is defined in each of the two positioning pieces 53. Two limiting tabs 533 extend towards each other from each of the two positioning pieces 53 and blocks the blocking member 60.

The blocking member 60 includes a blocking board 61 extending towards the bearing board 211. The blocking board 61 defines a locking hole 611 corresponding to the locking member 90. Two supporting bases 613 and two pivot pieces 615 are located on two opposite sides of the blocking board 61. Each of the two supporting bases 613 includes a connecting tab 6131 and a resisting tab 6133. The connecting tab 6131 is substantially perpendicularly connected to the blocking board 61. The resisting tab 6133 extends inwards from the connecting tab 6131 and is substantially parallel to the blocking board 61. The two pivot pieces 615 extend upwards from the blocking board 61 and are substantially perpendicular to the blocking board 61. A pivot hole 6151 is defined in each of the two pivot pieces 615, corresponding to the positioning hole 531 of the securing member 50.

The pivot shaft 70 includes a shaft body 71 and a pivot shaft head 73 located on one end of the shaft body 71. The shaft body 71 defines a ring slot 711 adjacent to another end of the shaft body 71, and the snap ring 80 is configured to be engaged in the slot 711. The pivot shaft 70 may be columnar, for example.

The snap ring 80 defines a cutout 81.

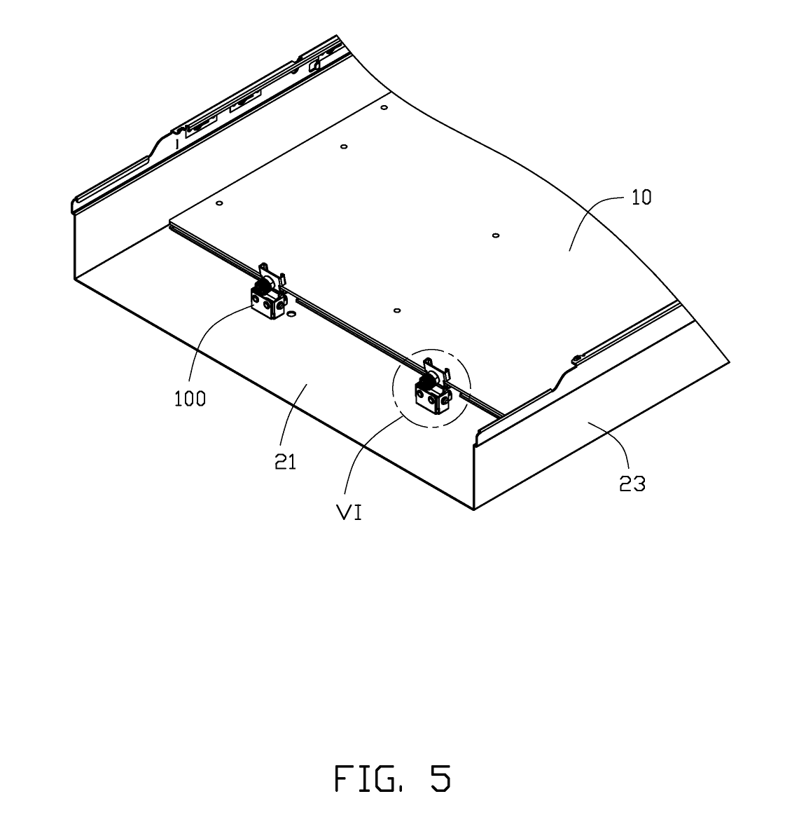

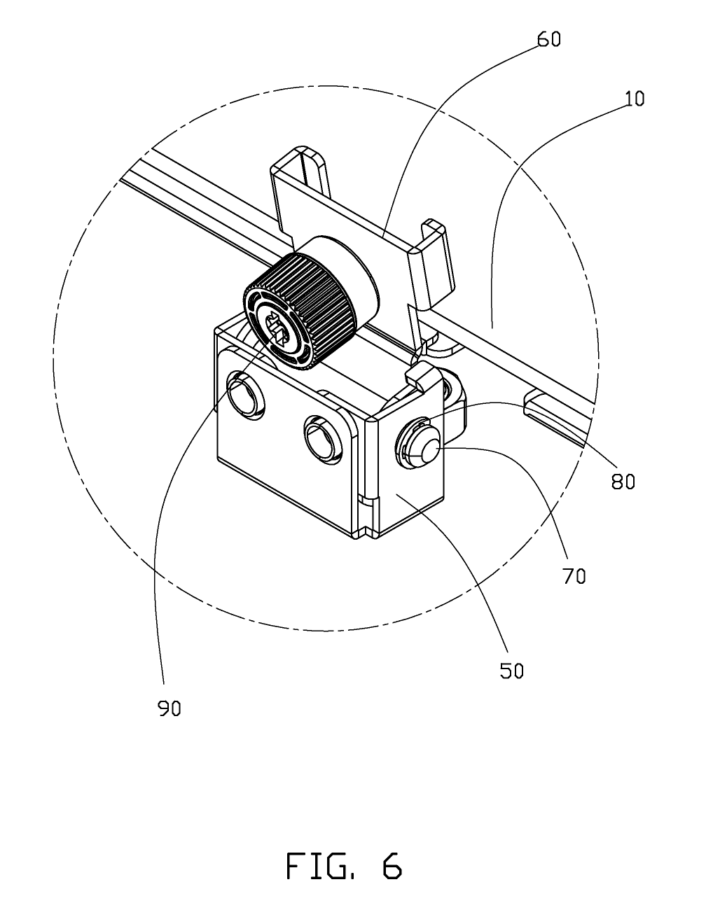

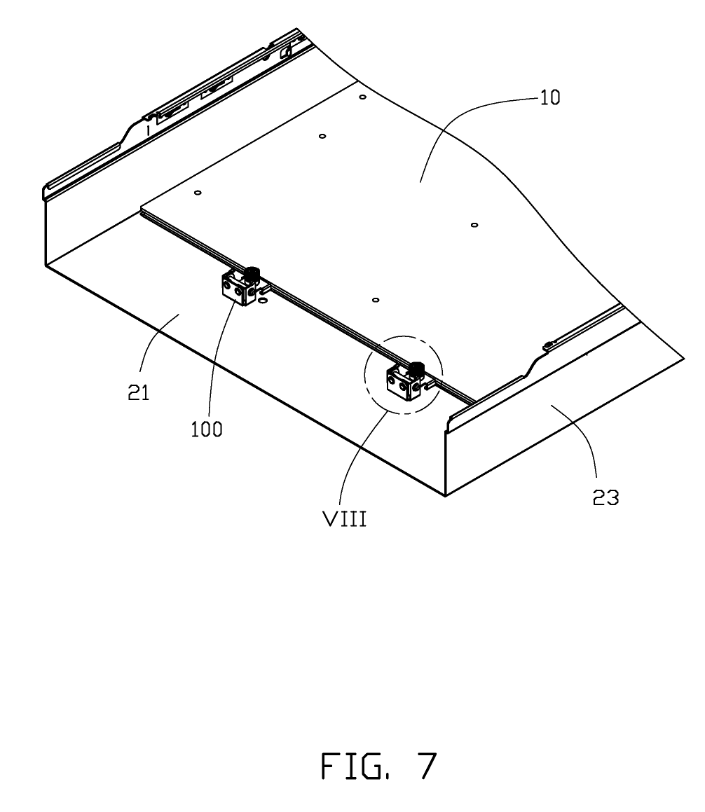

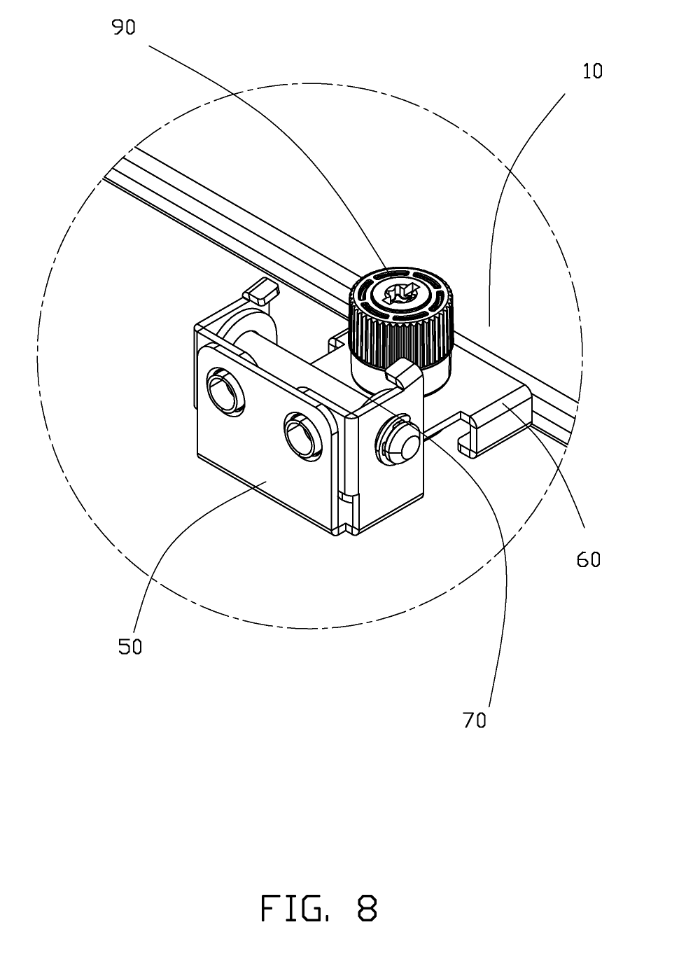

Referring to FIGS. 5-8, the two pivot pieces 615 of the blocking member 60 are located on inner side of the two positioning pieces 53 to align with the pivot hole 6151 of the two pivot pieces 615 with each of the two positioning holes 531. The shaft body 71 of the pivot shaft 70 extends through the two positioning holes 531 and through the two pivot holes 651, from one side of the two positioning pieces 53, until the slot 711 is exposed out of a side of a positioning piece 53. The pivot shaft head 73 abuts one of the two positioning pieces 53. The snap ring 80 snaps into the slot 711 via the cutout 81 and abuts another of the two positioning pieces 53. The locking member 90 is engaged in the locking hole 611. The fixing modules 100 is thereby assembled.

To install one of the two fixing modules 100 to the chassis 20, the fixing module 100 is located on front of the circuit board 10, and the blocking member 60 is adjacent to the circuit board 10. The installation holes 5111 of each fixing module 100 are aligned with a group of three securing holes 213, and three fasteners, such as screws, lock the three securing holes 213 and the installation holes 5111 together, to secure the fixing module 100 to the bottom plate 21. A user can apply force to the blocking member 60 to be rotated towards a first direction, until the blocking member 60 is located in a first position, where the blocking board 61 abuts the circuit board 10, and the two supporting bases 613 resist the bottom plate 21. The blocking board 61 is configured to prevent the circuit board 10 from moving along a direction parallel to the bottom plate 21. The locking member 90 is locked into the fixing hole 2151, to prevent the blocking board 61 from disengaging from the circuit board 10.

To release the circuit board 10, the locking member 90 is unlocked from the fixing hole. The blocking member 60 is rotated along a second direction, opposite the first direction, until the blocking member 60 is located in a second position, where the blocking board 61 is disengaged from the circuit board 10, and the two supporting bases 613 disengage from the bottom plate 21.

It is to be understood, however, that even though numerous characteristics and advantages have been set forth in the foregoing description of embodiments, together with details of the modules and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A mounting apparatus comprising:
a chassis comprising a bottom plate; and
a fixing module comprising a securing member and a blocking member, the securing member being secured to the bottom plate, the blocking member being rotatably secured to the securing member; and the blocking member being configured to block a circuit board, to prevent the circuit board from moving along a direction parallel to the bottom plate.

2. The mounting apparatus of claim 1, wherein the blocking member comprises a blocking board and two supporting bases located on the blocking board, the blocking board is configured to abut the circuit board, and the two supporting bases stand on the bottom plate.

3. The mounting apparatus of claim 2, wherein each of the two supporting bases comprises a connecting tab and a resisting tab connected to the connecting tab, the connecting tab is substantially perpendicular to the blocking board, and the connecting tab is substantially parallel to the blocking board.

4. The mounting apparatus of claim 1, wherein the blocking member comprises two pivot pieces, the securing member comprises two positioning pieces, and the two pivot pieces are rotatably attached to the two positioning pieces respectively.

5. The mounting apparatus of claim 4, wherein the fixing module further comprises a pivot shaft, each of the two pivot pieces defines a pivot hole, each of the two positioning pieces defines a positioning hole; and the pivot shaft extends through the pivot hole and the positioning hole, to secure the blocking member to the securing member.

6. The mounting apparatus of claim 5, wherein a stopping portion is located on the pivot shaft, the fixing module further comprises a snap ring, the stopping portion abuts one of the two positioning pieces, and the snap ring is engaged with the pivot shaft and abuts another positioning piece.

7. The mounting apparatus of claim 6, wherein the pivot shaft defines a slot, and the snap ring is engaged in the slot.

8. The mounting apparatus of claim 4, wherein two limiting tabs extend towards each other from the two positioning pieces respectively, and the two limiting tabs are capable of blocking the two pivot pieces.

9. The mounting apparatus of claim 4, wherein the securing member further comprises a securing board; and the securing board is secured to the bottom plate, to secure the securing member to the bottom plate.

10. The mounting apparatus of claim 2, wherein the fixing module further comprises a locking member engaged in the blocking board; the bottom plate defines a fixing hole;
and the locking member is locked into the fixing hole, to prevent the blocking member from disengaging from the bottom plate.

11. A mounting apparatus for a circuit board, comprising:
a chassis, the chassis comprising a bottom plate; and
a fixing module, the fixing module comprising a securing member and a blocking member, the securing member being secured to the bottom plate, and the blocking member being secured to the securing member and comprising a blocking board,
wherein the blocking member is rotatable between a first position and a second position; when the blocking member is located in the first position, the blocking board abuts the circuit board, to prevent the circuit board from moving along a direction parallel to the bottom plate; when the blocking member is located in the second position, the blocking board is disengaged from the circuit board, to release the circuit board.

12. The mounting apparatus of claim 11, wherein the blocking member further comprises two supporting bases located on the blocking board, when the blocking board is located on the first position, the two supporting bases stand on the bottom plate, to support the blocking board; when the blocking board is located on the second position, and the two supporting bases are disengaged from the bottom plate.

13. The mounting apparatus of claim 12, wherein each of the two supporting bases comprises a connecting tab and a resisting tab connected to the connecting tab, the connecting tab is substantially perpendicular to the blocking board, and the connecting tab is substantially parallel to the blocking board.

14. The mounting apparatus of claim 11, wherein the blocking member further comprises two pivot pieces, the securing member comprises two positioning pieces, and the two pivot pieces are rotatably attached to the two positioning pieces respectively.

15. The mounting apparatus of claim 14, wherein the fixing module further comprises a pivot shaft, each of the two pivot pieces defines a pivot hole, each of the two positioning pieces defines a positioning hole, and the pivot shaft extends through the pivot hole and the positioning hole, to secure the blocking member to the securing member.

16. The mounting apparatus of claim 15, wherein a stopping portion is located on the pivot shaft, the fixing module further comprises a snap ring, the stopping portion abuts one of the two positioning pieces, and the snap ring is engaged with the pivot shaft and abuts another of the two positioning pieces.

17. The mounting apparatus of claim 16, wherein the pivot shaft defines a slot, and the snap ring is engaged in the slot.

18. The mounting apparatus of claim 14, wherein two limiting tabs extend towards each other from the two positioning pieces respectively, and the two limiting tabs are capable of blocking the two pivot pieces.

19. The mounting apparatus of claim 14, wherein the securing member further comprises a securing board, and the securing board is secured to the bottom plate, to secure the securing member to the bottom plate.

20. The mounting apparatus of claim 11, wherein the fixing module further comprises a locking member engaged in the blocking board, and the bottom plate defines a fixing hole; when the blocking member is located on the first position, the locking member is locked into the fixing hole; when the blocking member is located on the second position, and the locking member is disengaged from the fixing hole.
